(19) United States
(12) Patent Application Publication
(10) Pub. No.: US 2014/0084214 A1
(43) Pub. Date: Mar. 27, 2014

(54) PROCESS FOR CATALYTIC STEAM REFORMING OF A FEEDSTOCK COMPRISING AN OXYGENATED HYDROCARBON AND A HYDROCARBON

(71) Applicant: Paul Adriaan Compagne, Scheemda (NL)

(72) Inventor: Paul Adriaan Compagne, Scheemda (NL)

(73) Assignee: BioMethano Chemie Nederland B.V., NL-9936 HD Farmsum (NL)

(21) Appl. No.: 14/116,489

(22) PCT Filed: May 7, 2012
(86) PCT No.: PCT/NL2012/050309

§ 371 Date: Nov. 25, 2013

(30) Foreign Application Priority Data
May 10, 2011 (EP) 11165502.3

(51) Int. Cl. C01B 3/26

(52) U.S. Cl. CPC C01B 3/26
USPC 252/373

(57) ABSTRACT

The invention relates to a process for catalytic steam reforming of a feedstock comprising an oxygenated hydrocarbon and a hydrocarbon, wherein during a first period of time the oxygenated hydrocarbon, the hydrocarbon and steam are supplied to an externally heated steam reforming catalyst under steam reforming conditions to produce synthesis gas and to obtain deactivated steam reforming catalyst and wherein during a second period of time, consecutive to the first period of time, the deactivated reforming catalyst is regenerated under steam reforming operating conditions by stopping the supply of the oxygenated hydrocarbon whilst maintaining the supply of the hydrocarbon and steam.

### FIELD OF THE INVENTION

The present invention relates to a process for catalytic steam reforming of a feedstock comprising an oxygenated hydrocarbon and a hydrocarbon.

### BACKGROUND OF THE INVENTION

In an effort to mitigate carbon dioxide emissions, the European Union has issued directives that set a minimum to the amount of automotive fuel derived from biomass. As a result, the production of biodiesel is steadily increasing. The availability of crude glycerol, a by-product of the production of biodiesel from triglycerides, is increasing accordingly. It is therefore important to find useful applications for glycerol. One of the possible applications is the conversion of glycerol into synthesis gas by catalytic steam reforming. Synthesis gas can then be converted into chemical feedstock or chemical products such as for example hydrocarbons (Fischer-Tropsch hydrocarbon synthesis) or methanol.

Catalytic steam reforming of hydrocarbons such as natural gas or methane is a well-known process that proceeds according to the following equation:

CₙH₍₂ₙ₊₂)+nH₂O [symbol] nCO+(2n+1)H₂ (1)

The steam reforming reaction is highly endothermic and is therefore typically carried out in an externally heated steam reforming reactor, usually a multi-tubular steam reformer comprising a plurality of parallel tubes placed in a furnace, each tube containing a fixed bed of steam reforming catalyst particles. The hydrocarbon feedstock is typically first pre-heated, usually in heat exchange contact with flue gas from the burners of the furnace, before it is supplied to the catalyst-filled tubes.

Likewise, oxygenated hydrocarbonaceous compounds such as ethanol or glycerol can be converted into synthesis gas according to the following equation:

CₙHₘOₖ+(n−k)H₂O [symbol] nCO+(n+m/2−k)H₂ (2)

In WO2008/028670 and WO2009/112476, for example, catalytic steam reforming of glycerol is disclosed.

In catalytic steam reforming processes, fouling of the catalyst bed by coke formation is a major problem. Typically at temperatures above 400 or 450° C., carbon-containing deposits are formed on metal catalysts in the presence of hydrocarbons and carbon monoxide. Such carbon deposits result in for example pressure drop problems and reduced catalyst activity due to covering of active catalyst sites. When oxygenated hydrocarbonaceous feedstocks are used, the coke formation problem is more pronounced, since oxygenated hydrocarbonaceous feedstocks such as ethanol or glycerol are more thermo-labile than hydrocarbons and therefore more prone to carbon formation.

In steam reforming processes, the deactivated or spent catalyst is typically regenerated by burning off the carbon in a separate burner or by oxidising the carbon by supplying steam to the reforming zone whilst stopping the supply of hydrocarbon feedstock.

In JP2009-298618 is disclosed a process for catalytic steam reforming of glycerol wherein used catalyst particles are continuously supplied to a burner to burn off the carbon deposits and then recycled to the steam reforming reactor.

In JP2008-238043 is disclosed a regeneration method wherein the supply of hydrocarbon-based feedstock is stopped and steam is continued to be supplied to the steam reforming zone. A disadvantage of the method of JP2008-238043 is that as a result of stopping the supply of hydrocarbon-based feedstock, synthesis gas production is also stopped during regeneration. Moreover, since the hydrocarbon-based feedstock is usually used as cooling means for cooling the flue gas from burners of the furnace, the heat integration during the regeneration period is negatively affected.

### SUMMARY OF THE INVENTION

It has now been found that in a process for catalytically steam reforming a feedstock that comprises both an oxygenated hydrocarbon and a hydrocarbon, catalyst regeneration can be carried out whilst keeping the catalyst in the steam reforming zone and whilst still producing synthesis gas. Thus, a separate burner or regenerator and/or shutting down of the steam reformer is not needed.

Accordingly, the invention relates to process for catalytic steam reforming of a feedstock comprising an oxygenated hydrocarbon and a hydrocarbon, wherein during a first period of time the oxygenated hydrocarbon, the hydrocarbon and steam are supplied to an externally heated steam reforming catalyst to produce synthesis gas and to obtain deactivated steam reforming catalyst and wherein during a second period of time, consecutive to the first period of time, the deactivated reforming catalyst is regenerated by stopping the supply of the oxygenated hydrocarbon whilst maintaining the supply of the hydrocarbon and steam.

It will be appreciated that after the second period of time, the supply of oxygenated hydrocarbon is typically resumed to repeat another cycle of first and second period.

### DETAILED DESCRIPTION OF THE INVENTION

In the process according to the invention, during a first period of time a feedstock comprising an oxygenated hydrocarbon and a hydrocarbon is converted into synthesis gas by contacting the feedstock and steam with a steam reforming catalyst. During the first period, oxygenated hydrocarbon, hydrocarbon and steam are supplied to the steam reforming catalyst under steam reforming conditions. As a result, synthesis gas is formed and the catalyst will gradually become deactivated due to deposition of carbon on the catalyst. Thus, deactivated steam reforming catalyst is obtained during the first period of time. During a second period of time, consecutive to the first period of time, i.e. directly following the first period, the deactivated reforming catalyst is regenerated. The regeneration is carried out by stopping the supply of oxygenated hydrocarbon to the catalyst whilst the supply of hydrocarbon and steam is maintained. Also the regeneration is carried out under steam reforming operating conditions.

After the second period of time, i.e. the regeneration, the catalyst activity will be increased, typically to a level approaching the original catalyst activity, and the supply of oxygenated hydrocarbon is typically resumed. Another sequence of first period with supply of oxygenated hydrocarbon and second (regeneration) period wherein the supply of oxygenated hydrocarbon is stopped will then typically be carried out.

The steam reforming process is preferably carried out in the absence of a molecular-oxygen containing gas both during the first and during the second period of time. If a molecular-oxygen containing gas would be supplied to the steam reforming catalyst, the amount of such gas is preferably such that the amount of molecular oxygen supplied to the catalyst is at most 10 vol % based on the total volume of oxygenated hydrocarbon and hydrocarbon supplied to the catalyst, more preferably at most 5 vol %, even more preferably at most 1 vol %. Carbon dioxide may be supplied to the catalyst, preferably in an amount of at most 10 vol % based on the total volume of oxygenated hydrocarbon and hydrocarbon supplied to the catalyst, more preferably at most 5 vol %, even more preferably at most 1 vol %. Preferably, no carbon dioxide is supplied to the catalyst.

Reference herein to steam reforming operating conditions is to conditions of temperature, pressure and gas space velocity under which steam reforming of a mixture of oxygenated hydrocarbons and hydrocarbons occurs during the first period and steam reforming of hydrocarbons occurs during the second period. Typically, steam reforming operating conditions comprise a temperature of the catalyst bed in the range of from 350 to 1,050° C., preferably of from 550 to 950° C., an operating pressure in the range of from 1 to 40 bar (absolute), preferably of from 10 to 30 bar (absolute), and a hourly space velocity of the total gas steam supplied to the catalyst, i.e. feedstock, steam and optionally molecular-oxygen containing gas or carbon dioxide, in the range of from 1,000 to 10,000 h⁻¹. The operating conditions during the second period of time may deviate from those during the first period of time.

During the first period, the feedstock comprises an oxygenated hydrocarbon and a hydrocarbon. Reference herein to oxygenated hydrocarbons is to molecules containing, apart from carbon and hydrogen atoms, at least one oxygen atom that is linked to either one or two carbon atoms or to a carbon atom and a hydrogen atom. Examples of suitable oxygenated hydrocarbons are ethanol, acetic acid, and glycerol. Examples of suitable hydrocarbons are natural gas, methane, ethane, biogas, Liquefied Petroleum Gas (LPG), and propane. Preferably, the feedstock comprises glycerol as oxygenated hydrocarbon. Preferably, the feedstock comprises natural gas, methane, biogas or LPG as hydrocarbon. A feedstock comprising glycerol and natural gas, methane or biogas is particularly preferred.

The weight ratio of hydrocarbon to oxygenated hydrocarbon in the feedstock is preferably in the range of from 1:1 to 3:1.

In order to effectively regenerate the catalyst during the second period of time, the ratio of molecules of steam to atoms of carbon (H₂O/C ratio) supplied to the catalyst in the second period preferably exceeds the ratio in the first period. More preferably, the ratio of molecules of steam to atoms of carbon supplied to the catalyst in the second period exceeds the ratio in the first period and the ratio is in the range of from 2.0 to 5.0 during the first period and in the range of from 3.0 to 6.0 during the second period, even more preferably in the range of from 2.0 to 3.5 in the first period and in the range of from 3.2 to 5.0 in the second period.

Preferably, the gas hourly velocity with which hydrocarbon and steam are supplied to the catalyst during the first period of time is maintained during the second period of time. Alternatively, however, the amount of steam supplied to the catalyst may be increased during the regeneration period, i.e. during the second period of time.

The steam reforming catalyst may be any steam reforming catalyst known in the art. Suitable examples of such catalysts are catalysts comprising a Group VIII metal supported on a ceramic or metal catalyst carrier, preferably supported Ni, Co, Pt, Pd, Ir, Ru and/or Ru. Nickel-based catalysts, i.e. catalysts comprising nickel as catalytically active metal, are particularly preferred and are commercially available.

In the process according to the invention, the catalyst is externally heated in order to provide for the heat needed for the endothermic steam reforming reaction. A typical steam reformer comprises an externally heated steam reforming zone containing a steam reforming catalyst, usually contained in a plurality of parallel tubes. The steam reforming zone is typically heated by means of a furnace fired by one or more burners. Such burners are typically supplied with fuel and an oxidant and hot flue gas is discharged from the burners. In the process according to the invention, the steam reforming catalyst is preferably externally heated by means of a burner, wherein the burner is supplied with a fuel and an oxidant and hot flue gas is discharged from the burner. More preferably, the feedstock is pre-heated during the first period of time by heat-exchange contact of the feedstock with the hot flue gas discharged from the burner and during the second period of time, the hydrocarbon is preheated by heat-exchange contact with the hot flue gas discharged from the burner.

Thus, an important advantage of the process according to the invention is that during the second period (regeneration period), a coolant for the hot flue gas is still available and thus, the heat integration as provided during the first period of time is not disturbed during the regeneration period.

### EXAMPLE

The process according to the invention will be further illustrated by means of the following non-limiting example.

A feed mixture consisting of natural gas, glycerol and steam was supplied to a multi-tubular steam reformer containing a Ni-based commercially available steam reforming catalyst. The amount of natural gas supplied was 37.5 .10³ cubic metres per hour (equivalent to 26.8 tons per hour), the amount of glycerol supplied was 12.0 tons per hour. The steam was supplied in such amount that the ratio of molecules of steam to atoms of carbon (H₂O/C ratio) supplied to the catalyst was 3.2. No molecular oxygen and no carbon dioxide were supplied to the catalyst. After 20 days of operation, the pressure drop over the catalyst tubes had steadily increased from 2.5 bar to 3.5 bar. The supply of glycerol was then stopped during 2 days whilst the supply of natural gas and steam was continued at the same supply rate as during the first 20 days. As a consequence, the H₂O/C ratio in the gas stream supplied to the catalyst increased to 4.0. After two days without glycerol supply, the pressure drop over the catalyst tubes had decreased to 2.5 bar and the glycerol supply was resumed. The process temperature and pressure were kept constant during the first and the second period.

1-11. (canceled)

12. A process for catalytic steam reforming of a feedstock comprising an oxygenated hydrocarbon and a hydrocarbon, the method comprising:
(a) supplying the oxygenated hydrocarbon, the hydrocarbon and steam to an externally heated steam reforming catalyst under steam reforming conditions to produce synthesis gas and deactivated steam reforming catalyst, and
(b) regenerating the deactivated reforming catalyst under steam reforming operating conditions by stopping the supply of the oxygenated hydrocarbon whilst maintaining the supply of the hydrocarbon and steam.

13. The process according to claim 12, wherein molecular-oxygen containing gas is not supplied to the catalyst.

14. The process according to claim 12, wherein at most 1 vol % of the total volume of oxygenated hydrocarbon and hydrocarbon supplied to the catalyst comprises molecular-oxygen containing gas.

15. The process according to claim 12, wherein the oxygenated hydrocarbon is glycerol.

16. The process according to claim 12, wherein the weight ratio of hydrocarbon to oxygenated hydrocarbon in the feedstock is between 1:1 to 3:1.

17. The process according to claim 12, wherein the hydrocarbon comprises natural gas, methane or biogas.

18. The process according to claim 12, wherein the ratio of molecules of steam to atoms of carbon supplied to the catalyst in (b) exceeds the ratio of molecules of steam to atoms of carbon supplied to the catalyst in (a).

19. The process according to claim 18, wherein the ratio of molecules of steam to atoms of carbon supplied to the catalyst is between 2.0 to 5.0 in (a) and between 3.0 to 6.0 in (b).

20. The process according to claim 12, wherein the steam reforming catalyst comprises a nickel-based catalyst.

21. The process according to claim 12, wherein the steam reforming catalyst is externally heated by a burner, wherein the burner is supplied with a fuel and an oxidant and hot flue gas is discharged from the burner.

22. The process according to claim 21, wherein during (a) the feedstock is preheated by heat-exchange contact of the feedstock with the hot flue gas discharged from the burner and during (b), the hydrocarbon is preheated by heat-exchange contact with the hot flue gas discharged from the burner.
